(19) United States
(12) Patent Application Publication
(10) Pub. No.: US 2006/0182928 A1
(43) Pub. Date: Aug. 17, 2006

(54) Cleaning article exhibiting reduced surface occlusion

(75) Inventors: Nick Carter, Mooresville, NC (US); Cheryl Carlson, Willow Springs, NC (US)

Correspondence Address: WOOD, PHILLIPS, KATZ, CLARK & MORTIMER, 500 W. MADISON STREET, SUITE 3800, CHICAGO, IL, 60661, US

(73) Assignee: Polymer Group, Inc.

(21) Appl. No.: 11/405,659

(22) Filed: Apr. 17, 2006

Related U.S. Application Data
(63) Continuation of application No. 10/428,562, filed on May 2, 2003, now abandoned.
(60) Provisional application No. 60/377,065, filed on May 2, 2002.

(51) Int. Cl. B32B 3/10

(52) U.S. Cl. 428/131

(57) ABSTRACT

The present invention is directed a nonwoven fabric cleaning article which is imparted with a three-dimensional image or pattern during the fabrication stage. The three-dimensional image or pattern imparted into the structure of the nonwoven fabric results in a material with a variable level of leading surface contact region as measured across the face of the fabric. The leading surface contact regions are present in the form of projections out of the planar background of the fabric, the prevalence of three-dimensional projections being such that the number and/or dimension of such projections increases as one moves away from the leading edges of the cleaning article.

### CROSS-REFERENCE TO RELATED APPLICATION

This application is a continuation of U.S. Ser. No. 10/428,562, filed May 2, 2003, which claims the benefit of priority Provisional Application No. 60/60/377,065, filed May 2, 2002, the disclosures of which are incorporated herein by reference.

### TECHNICAL FIELD

The present invention relates generally to a cleaning substrate, and specifically to a nonwoven fabric imparted with a three-dimensional pattern, which results in a material resistant to occlusion of the outer surface by contact with insoluble particulates, excess fluids, and accumulated foams or lathers, such material being imminently suitable for application in such cleaning and cleansing applications as hard-surface and personal hygiene.

### BACKGROUND OF THE INVENTION

The general use of nonwoven fabrics as a component in cleaning and cleansing articles is well known in the art. Various end-use articles are commercially available which utilize a combination of topical, performance enhancing additives and/or multi-layered laminate constructions. Use of such articles in personal cleaning and cleansing routinely include surfactants which either foam or lather as part of the cleaning process. In addition, enhanced versions of articles used in cleaning hard-surfaces further include an optional cleaning fluid application means, which applies a cleaning liquid to the surface prior to coming into contact with the face of the cleaning substrate.

A critical element of the aforementioned cleaning article is the use of porous facing materials that allow for the collection of particulates (as exemplified by dirt, dust, pollen, hair and exfoliated skin cells) into the component matrix of the substrate. Further, in light of the use of additional surfactants and cleaning liquids in conjunction with the cleaning article, it is necessary that these additional agents be absorbed into, and through, the matrix of the substrate.

A problem encountered when using such cleaning articles is the evident low utilization of the full contact face of the cleaning article during the cleaning of the soiled surface. Due to the occlusion of the porous facing by entrainment of insoluble foreign particulates and foams or lathers, and the resulting constrained fluidic absorbency, the fibrous matrix rapidly loses its ability to effectively clean. Further, compression of the cleaning article against the soiled surface induced by the application of pressure by the end-user, results in the only the foremost or leading contact region of the cleaning article being used. The degradation in performance of the leading contact region results in the combined failure of the cleaning article to collect additional particulates and fluids or foams, and the increased consumption of cleaning articles by the end-user necessary to clean the entirety of a surface.

A need exists for a cleaning article, which is better able to employ the entirety of the contact surface of the material, and is resistant to occlusion of the leading contact region of the contact surface due to entrainment of foreign insoluble particulates and/or contact with fluid cleaning agents or surfactant lathers.

### SUMMARY OF THE INVENTION

The present invention is directed a nonwoven fabric cleaning article which is imparted with a three-dimensional image or pattern during the fabrication stage. The three-dimensional image or pattern imparted into the structure of the nonwoven fabric results in a material with a variable level of leading surface contact region as measured across the face of the fabric. The leading surface contact regions are present in the form of projections out of the planar background of the fabric, the prevalence of three-dimensional projections being such that the number and/or dimension of such projections increases as one moves away from the leading edges of the cleaning article. Specific control over the prevalence of the three-dimensional projections improves the nonwoven fabric's ability to effectively collect particulates and fluids from the soiled surface by allowing a portion of the particulates and fluids to pass under the leading edge of the cleaning article, and to come into contact with projections located within the inner contact regions of the article. Therefore, more of the overall available surface of the cleaning article can be utilized to clean a given surface, with a corresponding increase in cleaning performance and/or cleaning article usable life cycle.

In accordance with the present invention, a method of making the nonwoven fabric embodying the present invention includes the steps of providing a precursor web comprising a fibrous matrix, such as provided by staple fiber, continuous filaments and the combinations thereof. In a particularly preferred form, the fibrous matrix is carded and cross-lapped to form a precursor web. It is also preferred that the precursor web be subjected to pre-entangling on a foraminous forming surface prior to imaging and patterning.

A method of making the present durable nonwoven fabric comprises the steps of providing a precursor web, which is subjected to hydroentangling. The precursor web is formed into an imaged and patterned nonwoven fabric by hydroentanglement on a three-dimensional image transfer device. The image transfer device defines three-dimensional elements against which the precursor web is forced during hydroentangling, whereby the fibrous constituents of the web are imaged and patterned by movement into regions between the three-dimensional elements of the transfer device.

In the preferred form, the precursor web is hydroentangled on a foraminous surface prior to hydroentangling on the image transfer device. This pre-entangling of the precursor web acts to integrate the fibrous components of the web, but does not impart imaging and patterning as can be achieved through the use of the three-dimensional image transfer device.

It is within the purview of the present invention, that one or more apertures can be formed in the surface contact region of the cleaning article. The one or more apertures can be present in a regular repeating interval, or the prevalence of the apertures may be varied across the face of the cleaning article so as to further control liquid absorbance or transmission.

It is also within the purview of the present invention that one or more performance modifying additives can be applied to the nonwoven substrate of the three-dimensionally imaged fabric. Representative performance modifying additives include those agents that enhance or modify the coefficient of friction between the cleaning article and the surface to be cleaned. One particularly preferred embodiment includes the topical application of a higher friction binder agent onto the contact portions of the leading edge of the three-dimensionally image fabric, and lower friction binder agent on to the trailing edge of the three-dimensionally image fabric, such that the coefficient of friction remains constant across the full contact surface of the cleaning article.

Other features and advantages of the present invention will become readily apparent from the following detailed description, the accompanying drawings, and the appended claims.

### BRIEF DESCRIPTION OF THE DRAWINGS

FIG. 1 is a diagrammatic view of an apparatus for manufacturing a nonwoven fabric, embodying the principles of the present invention;

FIG. 2 is a top plan view of a three-dimensionally imaged cleaning substrate whereby the primary leading edge comprises disconnected “nubs”;

FIG. 3 is a top plan view of a three-dimensionally imaged cleaning substrate whereby the primary leading edge comprises disconnected longitudinal “rails”;

FIG. 4 is a top plan view of a three-dimensionally imaged cleaning substrate whereby the primary and secondary leading edges comprises disconnected “nubs”;

FIG. 5 is a top plan view of a three-dimensionally imaged cleaning substrate whereby the primary and secondary leading edges comprises disconnected longitudinal “rails”;

FIG. 6 is a top plan view of a three-dimensionally imaged cleaning substrate whereby the primary leading edge comprises disconnected “nubs” and apertures;

FIG. 7 is a top plan view of a three-dimensionally imaged cleaning substrate whereby the primary leading edge comprises disconnected longitudinal “rails” and apertures;

FIG. 8 is a top plan view of a three-dimensionally imaged cleaning substrate whereby the primary and secondary leading edges comprises disconnected “nubs” and apertures;

FIG. 9 is a top plan view of a three-dimensionally imaged cleaning substrate whereby the primary and secondary leading edges comprises disconnected longitudinal “rails” and apertures;

FIG. 10 is a front view of a mop head configured so as to index the cleaning substrate across the mop face and present an unsoiled contact surface.

### DETAILED DESCRIPTION

While the present invention is susceptible of embodiment in various forms, there is shown in the drawings and will hereinafter be described a presently preferred embodiment of the invention, with the understanding that the present disclosure is to be considered as an exemplification of the invention, and is not intended to limit the invention to the specific embodiment illustrated.

The present invention is directed a nonwoven fabric which is imparted with a three-dimensional image or pattern during the fabrication stage. The three-dimensional image or pattern imparted into the structure of the nonwoven fabric results in three-dimensional fibrous projections that extend beyond the planar surface of the nonwoven fabric. Further, the three-dimensional image or pattern imparted into the structure of the nonwoven fabric results in a material with a variable level of surface contact region as measured across the face of the fabric. The surface contact regions are present in the form of projections out of the planar background of the fabric, the prevalence of three-dimensional projections being such that number of such projections increases as one moves away from the leading edges of the cleaning article. Specific control over the prevalence of three-dimensional projections improves the nonwoven fabrics ability to effectively collect particulates and fluids from the soiled surface by allowing a portion of the particulates and fluids to pass under the leading edge of the cleaning article, to come into contact with projections located within the inner contact regions of the article. Therefore, more of the overall available surface of the cleaning article can be utilized to clean a given surface, with a corresponding increase in cleaning performance and/or cleaning article usable life cycle.

It within the purview of the present invention, that one or more apertures can be formed in the surface contact region of the cleaning article. The one or more apertures can be present a regular repeating interval, or the prevalence of the apertures may be varied across the face of the cleaning article so as to further control liquid absorbance or transmission.

It is also within the purview of the present invention that one or more performance modifying additives can be applied to the nonwoven substrate of the three-dimensionally imaged fabric. Representative performance modifying additives include those agents which enhance or modify the coefficient of friction between the cleaning article and the surface to be cleaned. One particularly preferred embodiment includes the topical application of a higher friction binder agent onto the contact portions of the leading edge of the three-dimensionally image fabric, and lower friction binder agent on to the trailing edge of the three-dimensionally image fabric, such that the coefficient of friction remains constant across the full contact surface of the cleaning article.

The three-dimensional cleaning substrate is typically used either in sheet form by hand, or placed upon the head of a suitable mop as is readily and commercially available. Optionally, the three-dimensional cleaning substrate can be cut into continuous strips whereby the leading edge of the substrate is orientated in the direction of the strip edge. When the cleaning substrate is so formed, a roll of cleaning substrate may be used to index across the head of a mop, in a wind and unwind fashion, so as to present an unsoiled cleaning surface.

Fibers and/or filaments comprising the substrate layer of the present invention are selected from natural or synthetic composition, of homogeneous or mixed fiber length. Suitable natural fibers include, but are not limited to, cotton, wood pulp and viscose rayon. Synthetic fibers, which may be blended in whole or part, include thermoplastic and thermoset polymers. Thermoplastic polymers include polyolefins, polyamides and polyesters. The thermoplastic polymers may be further selected from homopolymers; copolymers, conjugates and other derivatives including those thermoplastic polymers having incorporated melt additives or surface-active agents. The cross sectional profile of the fiber and/or filament is not a limitation of the present invention.

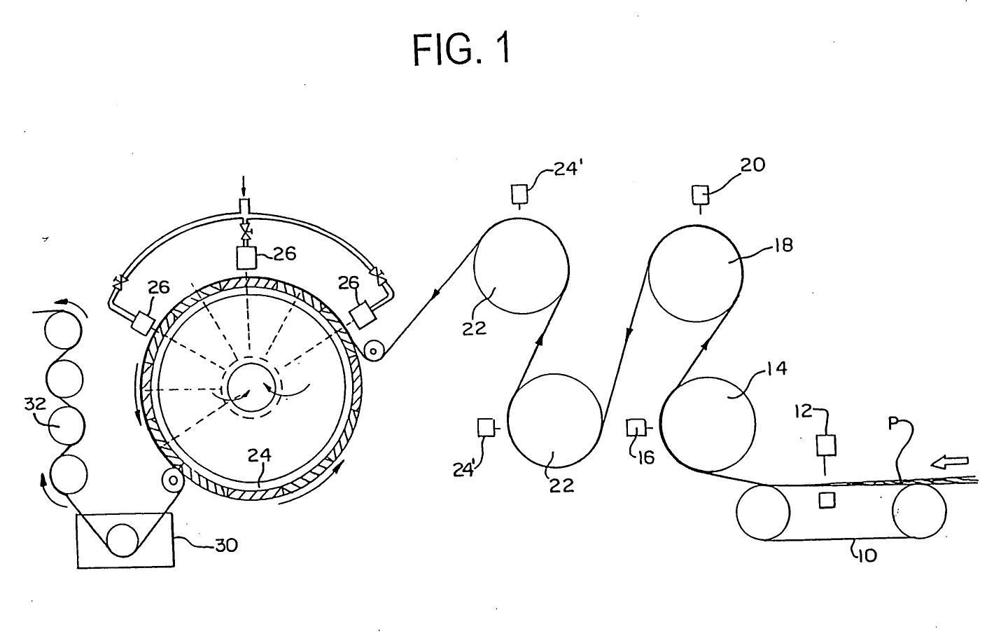

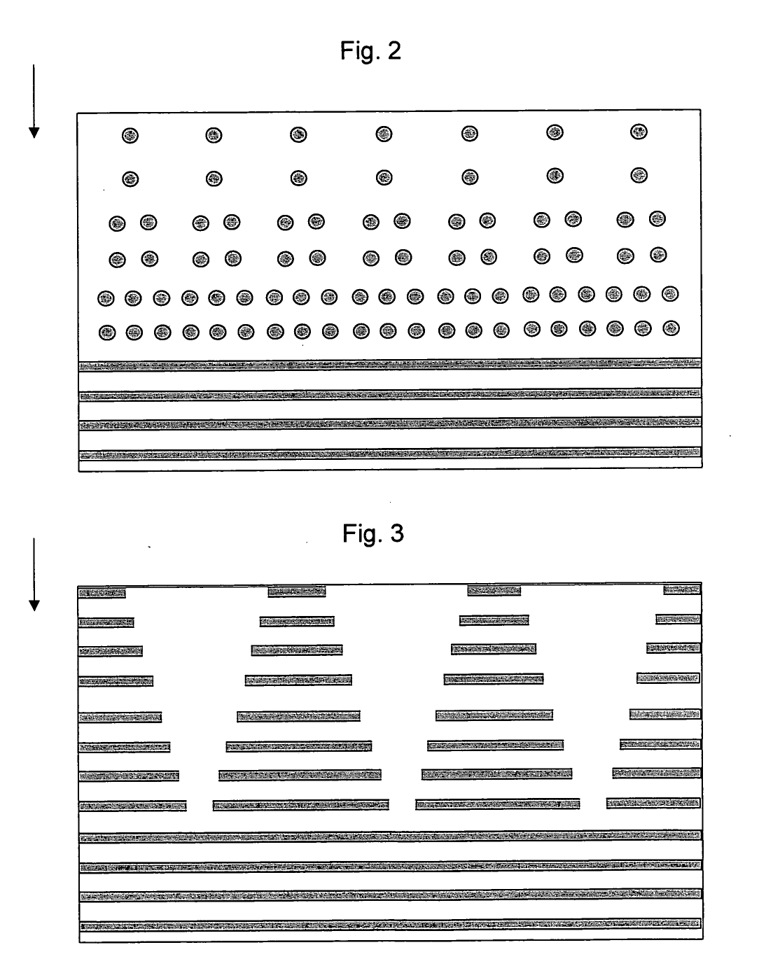

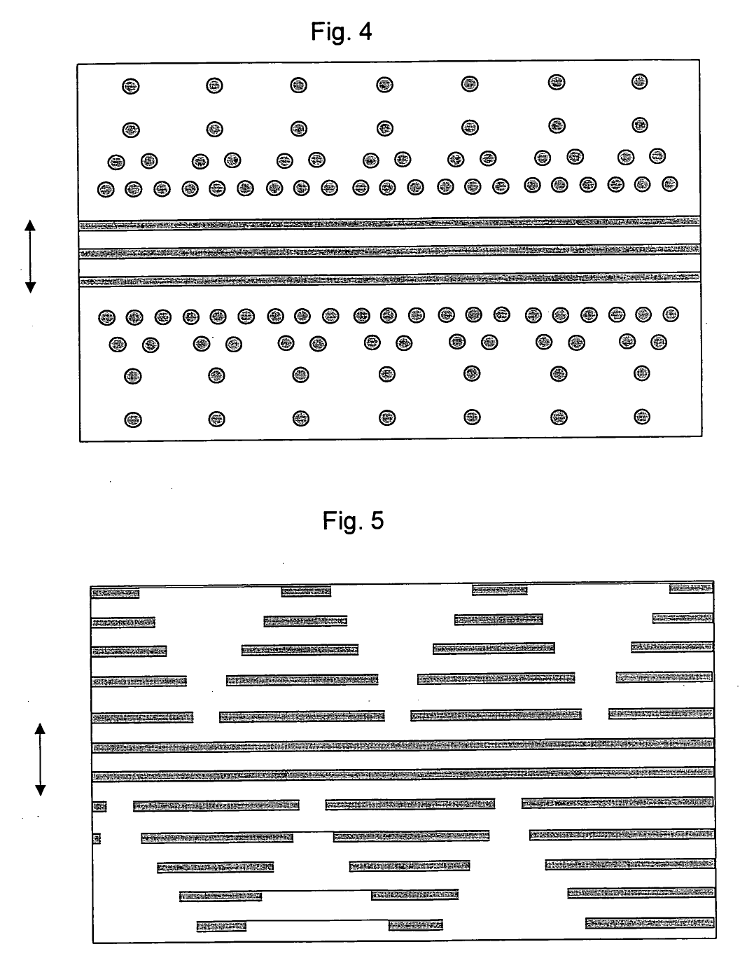

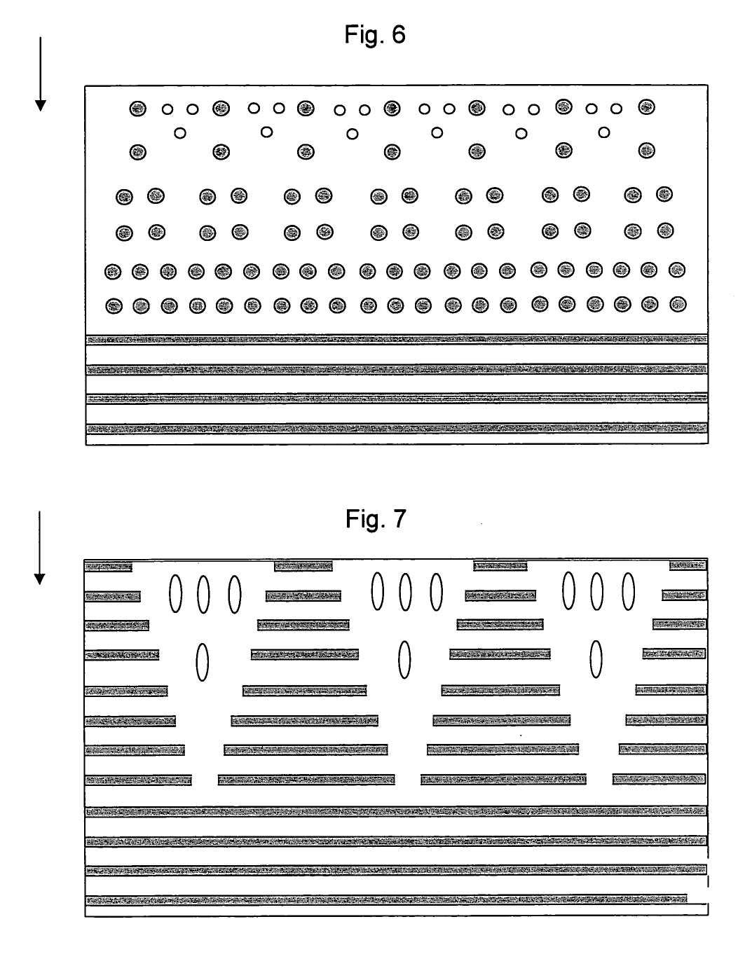

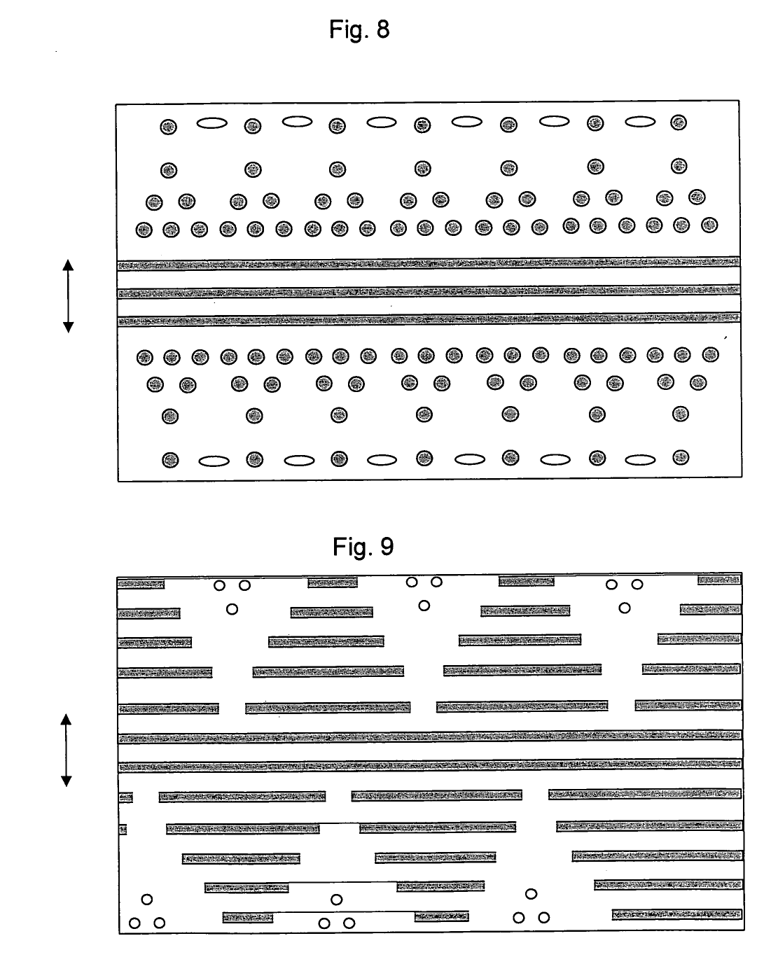

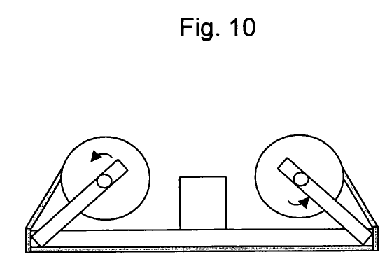

With reference to FIG. 1, therein is illustrated an apparatus for practicing the present method for forming a three-dimensionally imaged cleaning substrate. The substrate is formed from a fibrous matrix which typically comprises staple length fibers, and may optionally include continuous filaments. The fibrous matrix is preferably carded and cross-lapped to form a precursor web, designated P. In a current embodiment, the precursor web comprises a majority of cross-lap fibers, that is, most of the fibers of the web have been formed by cross-lapping a carded web so that the fibers are oriented at an angle relative to the machine direction of the resultant web.

FIG. 1 illustrates a hydroentangling apparatus for forming nonwoven fabrics in accordance with the present invention. The apparatus includes a foraminous forming surface in the form of belt 10 upon which the precursor web P is positioned for pre-entangling by entangling manifold 12. Pre-entangling of the precursor web, prior to imaging and patterning, is subsequently effected by movement of the web P sequentially over a drum 14 having a foraminous forming surface, with entangling manifold 16 effecting entanglement of the web. Further entanglement of the web is effected on the foraminous forming surface of a drum 18 by entanglement manifold 20, with the web subsequently passed over successive foraminous drums 20, for successive entangling treatment by entangling manifolds 24′, 24′.

The entangling apparatus of FIG. 1 further includes an imaging and patterning drum 24 comprising a three-dimensional image transfer device for effecting imaging and patterning of the now-entangled precursor web. The image transfer device includes a moveable imaging surface which moves relative to a plurality of entangling manifolds 26 which act in cooperation with three-dimensional elements defined by the imaging surface of the image transfer device to effect imaging and patterning of the fabric being formed.

Hydroentanglement results in portions of the precursor web being displaced from on top of the three-dimensional surface elements of the imaging surface to form an imaged and patterned nonwoven fabric. Enhanced surface fiber extension is desirably achieved, thus providing improved cleaning properties for the resultant fabric.

Manufacture of a three-dimensionally imaged substrate embodying the principles of the present invention is initiated by providing a precursor nonwoven web particularly chosen in light of the end-use application. Preferably, a blend of polyester and rayon fibers is selected for hard-surface cleaning, such a blend desirably provides good cleaning chemical compatibility, yet does not degrade the static charge developed by the polyester fibers. For personal cleaning and cleansing applications, 100% polyester fibers is preferably used. Optionally, a blend or layering, either through or transverse to the plane of the imaged substrate, of fibers having a difference in denier of at least 25% can improve the coefficient of friction for exfoliation and other cleaning purposes.

From the foregoing, it will be observed that numerous modifications and variations can be affected without departing from the true spirit and scope of the novel concept of the present invention. It is to be understood that no limitation with respect to the specific embodiments illustrated herein is intended or should be inferred. The disclosure is intended to cover, by the appended claims, all such modifications as fall within the scope of the claims.

What is claimed is:

1. A cleaning substrate, comprising;
a pre-bond fibrous matrix of fibers, said fibrous matrix being hydroentangled on a three-dimensional transfer device so as to impart a three-dimensional pattern into the resultant nonwoven fabric, the three-dimensional image or pattern imparted into the structure of the nonwoven fabric resulting in said substrate having a variable level of leading surface contact region as measured across the face of the fabric.

2. A cleaning substrate as in claim 1, wherein:
the fibrous matrix is selected from the group consisting of staple length fibers, continuous filaments, and blends thereof.

3. A cleaning substrate as in claim 2, wherein:
the blend of fibrous matrix consists of a blend of fibers and/or filaments having a difference in denier of at least 25%.

4. A cleaning substrate as in claim 1, wherein:
the leading surface contact regions are present in the form of projections out of the planar background of the nonwoven fabric, the prevalence of three-dimensional projections being such that the number and/or dimension of such projections increases as one moves away from the leading edges of the cleaning substrate.

5. A cleaning substrate as in claim 1, wherein:
one or more apertures are formed in the surface contact region.

6. A cleaning substrate as in claim 5, wherein:
the prevalence of the one or more apertures being such that the number and/or dimension of such apertures decreases as one moves away from the leading edges of the cleaning substrate.

7. A cleaning substrate as in claim 1, wherein:
one or more performance modifying additives are applied to the three-dimensionally imaged nonwoven fabric.

8. A cleaning article in accordance with claim 1, wherein:
the cleaning substrate is affixed to a mop head.
